(19) United States
(12) Patent Application Publication
(10) Pub. No.: US 2026/0212576 A1
(43) Pub. Date: Jul. 23, 2026

(54) INTERACTIVE VIRTUAL REALITY SYSTEM

(71) Applicant: Abu Dhabi University, Abu Dhabi (AE)

(72) Inventors: Heba Mahmoud Hassan Mohammed Ismail, Abu Dhabi (AE); Reem Ali Mohammed Alnaqeb, Abu Dhabi (AE); Maitha Hamad Amer Trais Almansoori, Abu Dhabi (AE); Fatema Mohamed Saeed Ghamadh Alrashdi, Abu Dhabi (AE)

(73) Assignee: Abu Dhabi University, Abu Dhabi (AE)

(21) Appl. No.: 19/031,682

(22) Filed: Jan. 18, 2025

(51) Int. Cl. G06T 13/40; A63F 13/57; G06T 13/20; G06T 13/80; G09B 7/02

(52) U.S. Cl. CPC G06T 13/40; A63F 13/57; G06T 13/205; G06T 13/80; G09B 7/02

(57) ABSTRACT

A method includes receiving electronic imagery. The method includes receiving electronic sound information. The method includes determining an electronically generated face based on the electronic imagery and the electronic sound information. The method includes receiving additional electronic sound information. The method includes determining to change the electronically generated face based on the additional electronic information.

### BACKGROUND

Presently, when individuals prepare for an interview, they need to not only anticipate the types of questions that they will be asked but also anticipate the behavior of the interviewer and also the environment within which the interview is being conducted. While a person can practice for an interview (whether a job interview, a college admittance interview, etc.), there is presently no electronic system that creates a technological solution for providing for electronic training used in interactive electronic systems which can be reduced computer resources

### BRIEF DESCRIPTION OF DRAWINGS

FIG. 1 is a diagram of an example flowchart;

FIG. 2 is a diagram of an example module;

FIG. 3 is a diagram of an example module;

FIG. 4 is a diagram of an example communication process;

FIG. 5 is a diagram of an example module;

FIG. 6 is a diagram of an example module;

FIG. 7 is a diagram of an example communication process;

FIG. 8 is a diagram of an example module;

FIG. 9 is a diagram of an example screenshot;

FIG. 10 is a diagram of an example screenshot;

FIG. 11 is a networking environment; and

FIG. 12 is a diagram of a computer.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein are for an immersive virtual reality (VR) experiences and GenAI-powered coaching system. In embodiments, the interactive system (e.g., the Gen-AI-powered coaching system) interview scenarios and provides personalized, adaptive gamified training, tailored to individual users'skills and experience levels. In embodiment, the interactive system comprises six core modules, each designed to enhance users'interview skills and readiness. By implementing the described interactive system, a reduction of individual electronic and computing systems may be reduced since the proposed interactive system is a combination of different system modules that require less computing resources.

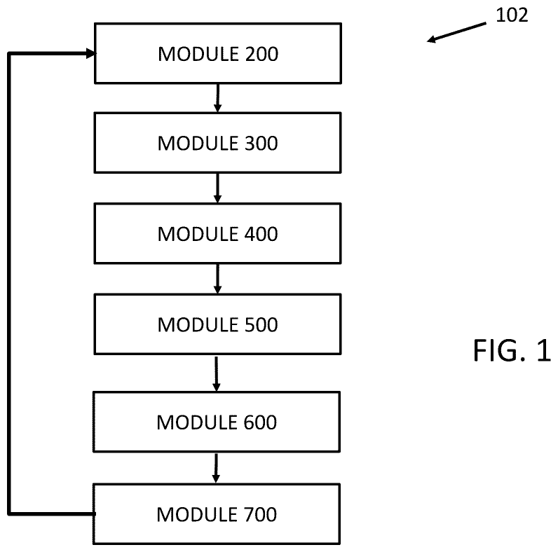

FIG. 1 shows an example diagram of interactive system 100. As shown in FIG. 1, interactive system 100 includes modules 200, 300, 400, 500, 600, and 700 which will be further described herein. In embodiments, interactive system 100 may conduct one or more of the electronic processes and communications described for one or more of the described modules. In embodiments, modules 200, 300, 400, 500, 600, and 700 describe different features and/or processes of interactive system 100.

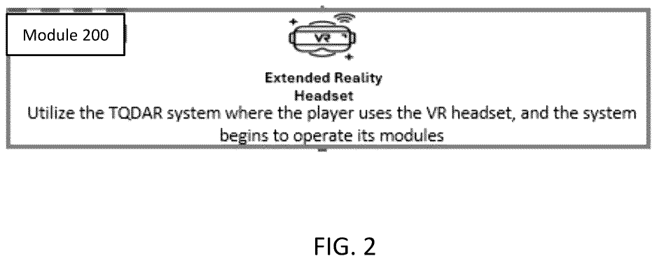

FIG. 2 describes examples module 200. In embodiments, module 200 may be a computing system that initiates an immersive training process and allows users of interactive system 100 to engage in the VR-based interview game through Extended Reality Headsets (which may be a part of interactive system 100). In embodiments, the user first creates an electronic account for use in interactive system 100. In embodiments, the electronic account may be created on the user's own device (e.g. smartphone, laptop, etc.). At module 300, in embodiments, the electronic account information may be received by interactive system 100 which records this information in a database and then presents a confirmation to the user (via another electronic communication).

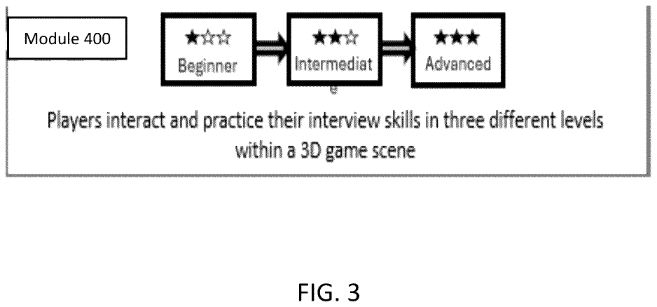

As shown in FIG. 3, module 300 secures storage of user data in the system's database and manages the user's access to training levels. In embodiments, module 300 maintains data privacy and integrity throughout, from account creation to in-game activity.

In module 400, once authenticated (by a server associated with interactive system 100), an electronic interface allows users to electronically access gamified training levels-Beginner, Intermediate, and Expert (as shown in FIG. 3). In embodiments, the Beginner Level focuses on the fundamentals of interview preparation, including basic question-answering techniques and initial exposure to common interview settings. In embodiments, the Beginner Level is an introductory level that is designed for users with little to no interview experience, focusing on foundational skills and confidence building.

It includes simple question-and-answer exercises, helping users become familiar with common interview formats and basic etiquette. In embodiments, the AI system provides constructive feedback after each question, offering tips on body language, tone, and structuring responses. This level serves as a low-stress, confidence-boosting environment, encouraging users to build a solid groundwork before moving on to more complex challenges.

In embodiments, the Beginner Level process includes the AI system requesting electronic information. For example, the AI system can ask “tell me about yourself” which encourage users to practice structuring a concise, clear personal introduction. The AI system can also ask “what are your strengths and weaknesses?” This question familiarizes users with self-assessment questions, guiding them to frame responses positively and constructively. The AI system can also ask “why are you interested in this position?”

The AI system can ask “how do you handle stress or pressure? This question helps to start building a foundation for behavioral questions, encouraging users to share personal experiences. The AI system can ask “describe a time when you worked as part of a team?” This question is the purpose of introducing teamwork-related questions with simple scenarios.

In embodiments, the Intermediate Level introduces moderately complex interview scenarios, designed for users with some prior interview experience or preparation. The questions become more nuanced, encouraging the Player to think critically. At the Intermediate Level, the training introduces more intricate interview scenarios. Questions are designed to be moderately challenging, requiring users to apply critical thinking and develop structured responses. In embodiments, the AI system may simulate scenarios such as role-specific questions or competency-based queries that demand examples of past experiences. In embodiments, gamification elements like progress bars, achievements, and in-game rewards keep users motivated, while adaptive difficulty ensures that the experience remains challenging but achievable. Users are encouraged to refine their responses based on real-time feedback, focusing on skills such as articulating thought processes, handling unexpected questions, and demonstrating problem-solving abilities.

In embodiments, at the Intermediate Level, the electronic requests from the AI system become more nuanced and may include situational and competency-based elements that require users to demonstrate critical thinking and past experiences. For example, the AI system can ask “describe a challenging project you worked on? What was your role, and how did you overcome the challenges?” This question encourages users to discuss specific experiences, highlighting problem-solving and resilience. The AI system can ask “how do you prioritize tasks when you have multiple deadlines?” This question helps to determine test time-management skills and the ability to articulate strategies for handling pressure. In embodiments, the AI system can ask “can you give an example of a time when you had to learn something quickly to meet a deadline? How did you approach it?” The reason for this question is to assess adaptability and initiative, pushing users to reflect on real-life learning experiences.

The Advanced Level challenges users with high-pressure interview simulations that include industry-specific questions, behavioral assessments, and problem-solving tasks. In embodiments, at the Advance Level simulates high-stakes interview environments, replicating complex behavioral assessments. It includes stress-inducing elements such as multi-part questions to simulate real-life pressure. The AI dynamically adapts to the user's performance, introducing high-level questions that require specialized knowledge, in-depth answers, and a demonstration of emotional intelligence and strategic thinking. By completing this level, users gain experience with the kind of challenging questions often encountered in actual high-level interviews.

For example, the AI system can ask “you are given a project with limited resources and a tight deadline. How would you plan and execute it?” The purpose of this question is to assess project management skills and ability to strategize under constraints, simulating real-world challenges. The AI system can ask “describe a situation where you took a risk at work. What was the outcome, and what did you learn?” The purpose of this question is to evaluate decision-making abilities and risk management, focusing on reflective learning from experiences.

Each level adapts dynamically based on user performance, with the AI modifying the difficulty and complexity of questions in real-time, providing a highly personalized experience. Each level is enhanced by AI-driven adaptability, which personalizes the experience for each user. The system tracks user progress, response accuracy, and confidence, adjusting the question difficulty and providing targeted feedback. For instance, if a user struggles with a particular type of question, the system may adjust the frequency of similar questions, within a particular amount of time, to reinforce learning, creating a highly customized path to mastery. This adaptation keeps users in a state of “flow,” ensuring they are continually challenged without feeling overwhelmed. In embodiments, flow refers to a psychological state where users are fully engaged and immersed in the interview training activity, balancing challenge and skill to maintain motivation and focus. In embodiments, the technical process of achieving flow occurs through AI-driven adaptability that ensures the user experiences neither boredom from overly simple questions nor frustration from excessively difficult ones. This is accomplished by the user demonstrating mastery, the system increases the difficulty, introducing nuanced or challenging scenarios. If the user struggles, the system then reduces the complexity or provides easier questions, allowing the user to rebuild confidence and improve foundational skills. Thus, the system provides different electronic information at different time periods based on the user's electronic communications (provided either audibly, visually, or textually).

To increase engagement, the system employs a range of gamification techniques. Progress is visualized through level indicators, achievements, and badges awarded for milestones such as completing levels without errors or responding within a time limit. The levels are designed not only to assess and improve interview skills but also to create an enjoyable and interactive training experience, where users feel motivated to improve and reach the next level. This multi-level, gamified approach allows users to progress at their own pace, building confidence and skill through increasingly realistic and complex interview scenarios. By the end of the training, users are well-prepared for real-world interviews, having developed both the technical and soft skills needed to succeed.

In embodiments, the user can select their desired level from interactive system 100, triggering the transition to the training level screen (e.g., part of a virtual headset, a laptop display screen, a smartphone, etc.). From there, the user can then use the headset to view interview sessions designed to mimic real-world interview environments through realistic, fully animated “Metahuman” interviewers (e.g., avatar). In embodiments, the avatar can replicate natural mouth movements and facial expressions (how is this done as far as relationship to answers provided), providing a lifelike experience as the avatar poses questions.

In embodiments, metahuman avatars serve as realistic interviewers, adapting their body language, voice modulation, and facial expressions in response to the user's answers. In embodiments, this adaptation creates a lifelike and interactive training environment for interview practice. In embodiments, the metahuman avatars can have contextual body language and movement. In embodiments, interactive system 100 allow the metahuman interviewer to adopt contextually appropriate body language based on the user's responses. For example, if the user responds confidently, the metahuman interviewer might nod or lean slightly forward to convey engagement and interest. In embodiments, interactive system 100 may determine a confidential response based on the level of tone, the types of words being used, and the fluency level (captured via the fine-tuned LLM). Alternatively, if the user's response is hesitant or unclear (e.g., the user does not speak into the microphone, the words are not understood, or the pace of words is too fast, too slow, or stuttered), the metahuman interviewer might tilt their head slightly or maintain a neutral posture, signaling the need for more clarity or elaboration.

In embodiments, confidence is assessed based on 2 core factors, as integrated into the LLM's scoring mechanism for tone and language. This includes tone analysis in which the LLM evaluates the tone of the response for markers of confidence, such as assertiveness and positivity. In embodiments, high confidence is indicated by decisive statements like “I led the project to success,” while uncertainty is flagged in phrases like “I think I helped with the project.” This also includes speech delivery in which the system tracks fluency and pace metrics. In embodiments, fluency includes responses with minimal filler words (e.g., “uh,” “um”) and coherent delivery score higher for confidence. In embodiments, pace indicates a steady pace indicates composure, while rushed or overly slow responses suggest nervousness.

In embodiments, the electronic generated metahuman's body language dynamically adapts to reflect the confidence level detected. In embodiments, for confident responses, the avatar nods or leans slightly forward to signal engagement. In embodiments, for hesitant responses, the avatar might pause, tilt its head, or maintain a neutral posture, prompting clarification or elaboration. In embodiments, mastery evaluation logic mastery is tied closely to the content scoring logic and reflects the depth, relevance, and structure of the user's answers. In embodiments, content quality and specificity are evaluated by the LLM to evaluate whether the response directly addresses the question, and uses domain-specific terminology, and includes detailed examples. In embodiments, for structure and logical flow, he LLM identifies whether the response follows a coherent structure. For instance, disorganized responses prompt feedback to improve structuring, such as “Your answer needs more structure. Start with the situation, describe your task, explain the actions you took, and conclude with the result.”

In embodiments, the metahuman can also adapt in real-time. In embodiments, the Metahuman interviewer uses non-verbal cues to reflect mastery. For example for clear, detailed responses, the avatar may generate an electronic smile or give an approving nod. For incomplete or generic answers, the avatar may display a neutral or slightly questioning expression, signaling a need for elaboration.

In embodiments, interactive system 100 enable the interviewer to perform realistic, dynamic gestures based on user responses. For example, the metahuman interviewer might adjust hand gestures or subtle posture shifts to indicate active listening or to emphasize points in follow-up questions, making the interaction feel natural and responsive.

In embodiments, interactive system 100 allows the metahuman interviewer's vocal tone to change based on the type of answer provided by the user. If the user's response is thoughtful or introspective, the interviewer's voice might slow slightly and soften, indicating empathy or deeper engagement. For more straightforward answers, the interviewer could maintain a neutral or professional tone, creating an adaptable auditory experience. In embodiments, the metahuman's voice can adapt dynamically to the user's responses, with slight adjustments in speed and intonation based on the content and perceived confidence of the answer. For example, if the user's response is hesitant, the interviewer might slow down slightly in their next question or speak in a more encouraging tone to create a supportive atmosphere.

### 3. Adaptive Facial Expressions to Reflect Active Listening

In embodiments, interactive system 100 enables the metahuman interviewer to display realistic facial expressions that match the tone of the user's responses. If the user provides an insightful answer, the metahuman interviewer may graphically show raised eyebrows slightly or give a small nod to indicate understanding and encouragement. For responses that lack clarity or require elaboration, the metahuman interviewer might maintain a neutral expression, indicating that more information is expected.

In embodiments, interactive system 100 phoneme-to-viseme mapping ensures that the metahuman interviewer's lip movements are in sync with their spoken words. For each response from the user, the interviewer's mouth and facial expressions are accurately animated, creating a realistic conversational flow where the interviewer's expressions align with the delivery of each question and follow-up prompt.

In embodiments, phonemes: are the smallest units of sound in speech (e.g., the “p” sound in “pat” or the “ee” sound in “see”). In embodiments, visemes are the visual counterparts of phonemes, representing the shape and movement of the mouth and face when a particular sound is spoken (e.g., lips together for “p” or lips stretched for “ee”). In embodiments, mapping is when system translates the audio phonemes into corresponding visemes, ensuring that the Metahuman interviewer's mouth shapes accurately represent the sounds being spoken. In embodiments, phoneme-to-viseme mapping includes audio analysis. When the Metahuman speaks a line (e.g., a follow-up question or comment), the system breaks the audio into phonemes using speech synthesis or pre-recorded voice data. In embodiments, viseme synchronization includes where each phoneme is mapped to a predefined viseme in the Metahuman's facial rig. For example, the “b” sound corresponds to lips pressed together, and the “o” sound corresponds to rounded lips. This mapping ensures that the Metahuman's lip movements appear natural and synchronized with the audio.

In embodiments, dynamic animation is applied, so that viseme animations to the Metahuman's facial rig occur in real-time or during pre-rendering, ensuring that the lip movements and facial expressions match the timing and rhythm of the spoken words.

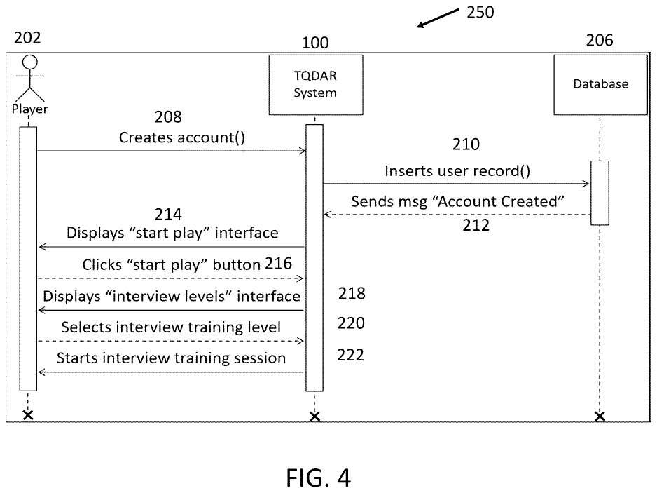

FIG. 4 shows an example electronic communication flow system 250 that describes the electronic processes and communications that occur with modules 200, 300, and 400. As shown in FIG. 4, user device 202 sends electronic communication 208 to interactive system 100. In embodiments, interactive system 100 sends an insert record 210 which is an electronic communication to database 206. In embodiments, database 206 electronically analyzes the electronic information received by validating one or more elements of the user's electronic information. Once database 206 has confirmed the user's electronic information, database 206 sends electronic message 212 to interactive system 100 that an electronic account has been created.

In embodiments, interactive system 100 sends an electronic communication to user device 202 that, based on the electronic communication, generates an electronic display with an indication that an account has been generated and for the user (via user device 202) to select play. In embodiments, user device 202 may be a smart phone, a VR headset, or multiple user devices being used by a user such as a smart phone and a VR headset.

At 216, the user clicks on a start button on user device 202 which sends an electronic communication to interactive system 100. In embodiments, interactive system 100 then sends electronic communication 218 to user device 202 which generates different interview levels for the user to select from. At 220, user device 202 sends an electronic communication to interactive system 100 that indicates the training level. In embodiments, interactive system 100 receives electronic communication 220 and, based on 220, interactive system 100 sends electronic communication 222 which starts the electronic interview process to user device 202.

In embodiments, interactive system 100 may be part of a separate computing device from user device 202. Alternatively, interactive system 100 may be a part of one or more user devices 202 that interact with each other; or interactive system 100 may be part of separate computing device and part of one or more user devices 202. In embodiments, database 206 may be a separate computing system from interactive system 100; or, database 206 may be a part of interactive system 100.

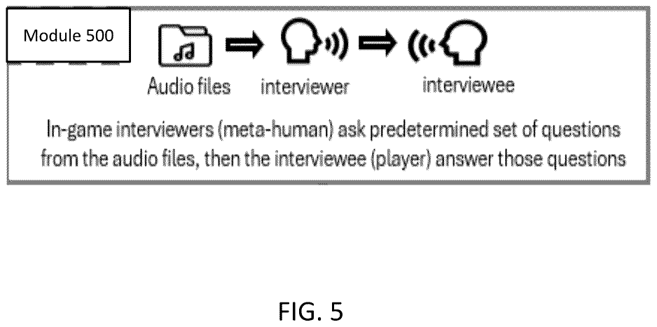

FIG. 5 describes module 500. In embodiments, module 500 is responsible for managing the execution of VR-based interview sessions. As discussed with module 400, the user selects a training level of his choice to calibrate interactive system 100 and train it on the user's mastery level. In embodiments, the system transitions into an immersive environment where a metahuman interviewer poses questions. In embodiments, each level is enhanced by AI-driven adaptability, which personalizes the experience for each user. In embodiments, the system tracks user progress, response accuracy, and confidence, adjusting the question difficulty and providing targeted feedback. For example, if a user struggles with a particular type of question, the system may adjust the frequency of similar questions to reinforce learning, creating a highly customized path to mastery. This adaptation keeps users in a state of “flow,” ensuring they are continually challenged without feeling overwhelmed.

In embodiments, the immersive environment may be displayed via a VR headset. In embodiments, the metahuman's facial expressions, speech, and movements are synchronized to create a lifelike experience, making the interview as realistic as possible. In embodiments, the session begins with the user interacting with the metahuman. In embodiments, the metahuman asks interview questions, which are tailored to the selected training level. As the user responds, interactive system 100 leverages the speech-to-text API to capture and convert audio responses into text, which is then transmitted to the AI model for evaluation. Accordingly, this interaction sequence is reflected in the system's design and operation, where real-time question delivery, response capture, and evaluation are integrated to provide an authentic interview experience.

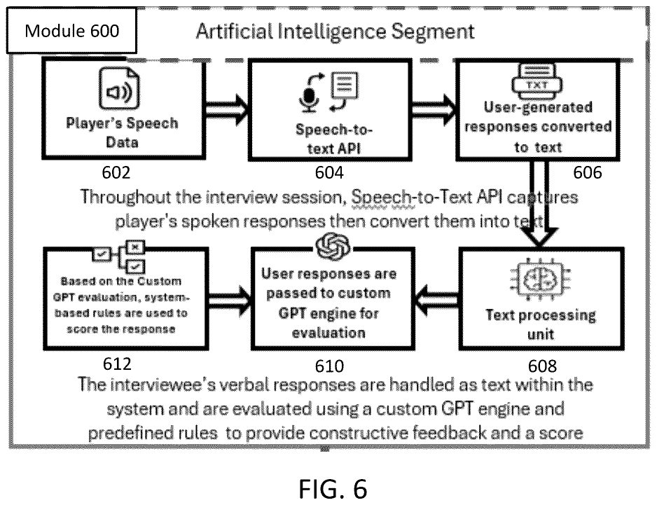

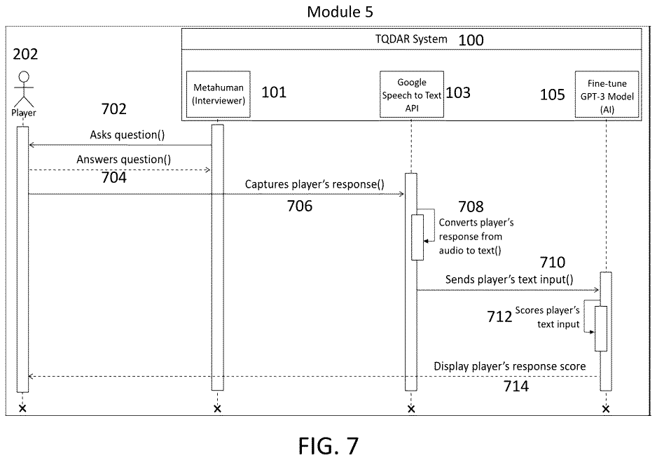

FIGS. 6 and 7 describe module 600. In embodiments, this module utilizes advanced AI technology to evaluate the Player's responses. Once the Player provides an answer, a speech-to-text API converts the spoken responses into text, which is sent to the AI model for analysis. In embodiments, the AI model assesses the content of the responses in real-time, providing objective scoring based on the quality, relevance, and clarity of the answers. In embodiments, the evaluation also includes feedback on language, tone, and content allowing users to improve their response time. In embodiments, the GenAI-powered system ensures continuous learning by delivering instant feedback tailored to the Player's skill level and performance.

In embodiments, predefined evaluation criteria are also determined. In embodiments, the scoring system is based on clearly defined parameters that measure specific aspects of the user's response. This includes quality which assesses the overall coherence and depth of the response to determine whether the answer provide clear, complete, and relevant information. In embodiments, relevance which determines whether the response directly addresses the question or deviates from the topic. In embodiments, clarity includes evaluating the ease of understanding, including grammatical accuracy, logical flow, and avoidance of ambiguity. In embodiments, these criteria are consistent and measurable, reducing subjective variability.

In embodiments, the AI model uses quantifiable linguistic and contextual features to evaluate responses. This includes evaluating language which includes counting grammatical errors, filler words, or improper vocabulary use. This also includes measuring sentence complexity and word choice appropriateness. This also includes evaluating tone which includes analyzing sentiment (e.g., confidence, positivity), and also detects hesitations or overly tentative language that might undermine the tone. This also includes evaluating content which includes checking for specific, actionable details or examples in the response and uses keyword analysis to detect alignment with question prompts. In addition, assessment of logical structure (e.g., whether the response follows the STAR method) is conducted. In embodiments, each feature is scored individually, contributing to an aggregate performance score.

In embodiments, the overall performance score provided by the TQDR system is calculated by the fine-tuned Large Language Model (LLM), which evaluates the user's response on three main dimensions: language, tone, and content. In embodiments, each of these dimensions is weighted based on its importance to a successful interview response, contributing to a holistic score that reflects the user's overall performance.

In embodiments, each dimension (language, tone, and content) represents critical aspects of interview performance, with specific importance ascribed to each. In embodiments, language (e.g., 30% weight) includes proper grammar, vocabulary, and clarity are foundational for professional communication. In embodiments, language is essential but not the sole factor, as tone and content add critical layers. In embodiments, the tone (e.g., 30% weight) includes an appropriate, confident, and positive tone is necessary to convey professionalism and readiness, particularly in high-stakes interviews.

In embodiments, content (e.g., 40% weight) carries the highest weight because relevance, depth, and structure are crucial to addressing interview questions fully and effectively. In embodiments, high-quality content often reflects knowledge, experience, and critical thinking skills, which are essential in any interview setting. In embodiments, for the scoring mechanism, each response is scored separately on language, tone, and content using LLM-based analysis. In embodiments, the LLM generates scores for each dimension. In embodiments, the LLM assesses vocabulary, grammar, and clarity, rating each on a scale (e.g., 0-10). This dimension's score is based on an average of these factors, weighted at 30%.

In embodiments, tone score calculation is based on confidence, positivity, and appropriateness to the question. In embodiments, the LLM identifies markers such as assertive language for confidence, constructive framing for positivity, and matching tone to question type for appropriateness. In embodiments, the average score of these markers, weighted at 30%, determines the tone score. In embodiments, content is rated on relevance, specificity, and structure, with the LLM checking if the response addresses the question, provides necessary detail, and follows a logical flow. In embodiments, content is weighted highest at 40%, and this dimension's score is an average of the ratings for relevance, specificity, and structure. In embodiments, the final performance score is calculated as a weighted average of the three dimensions'scores, following this formula: Performance Score=(Language Score×0.3)+(Tone Score×0.3)+(Content Score×0.4).

In embodiments, the LLM provides targeted feedback to help users improve their responses in terms of language, tone, and content. This feedback is based on specific areas identified during the evaluation, allowing users to refine their answers with actionable suggestions. In embodiments, the feedback assists the user to reduce computing and communication resources when the user is conducting another electronic communication (e.g., with a real-life person using a computing device).

In embodiments, the LLM processes responses in real time but focuses feedback only on specific areas needing improvement, rather than analyzing the entire response exhaustively. This includes targeted feedback which includes narrowing feedback to language, tone, or content as needed, the system minimizes unnecessary computational overhead. This also includes selective evaluation where the system concentrates on newly identified deficiencies instead of reprocessing unchanged aspects of the user's behavior (e.g., repeating tone evaluation for consistently confident users). In embodiments, the training system equips users with refined communication skills, reducing the need for additional real-time computational resources during actual electronic communications (e.g., video calls, chats).

For example, feedback may be: “Consider rephrasing your response to avoid filler words like ‘kind of’ and ‘maybe.’ Instead of ‘I kind of worked on the project,’ try, ‘I played a key role in the project's success.’ This phrasing is more confident and direct.”

As shown in FIG. 6, speech data 602 of the electronic speech (i.e., spoken words) of the user of interactive system 100 is sent to a speech-to-text API 604. In embodiments, speech-to-text API 604 then generates text 606 which is then sent to text processing unit 608 which includes tokenizing the text without removing fillers, grammatical errors or any other common language processing because these are considered in this context critical indicator of the interviewees performance when it comes to confidence and clarity of the answer. In embodiments, tokenization is dividing the text into individual tokens (typically words or sub-words). In embodiments, this allows the LLM to analyze text at a granular level, understanding each token's role within the sentence. For example, one token that is for an misspoken word may be given a value that is based on the (1) the location of the misspoken word within a sentence (2) the importance of the misspoken word within the sentence, (3) the number of times the word is misspoken, (4) any additional time taken that relates to the word, (5) any change in tone related to a particular word that is different to the tone relating to other words, and/or (6) any other issues.

This includes location of the misspoken word within a sentence. This includes evaluating the placement of the error in the sentence, as some locations (e.g., at the beginning or conclusion) may have a greater impact on perceived clarity and confidence. Thus, errors at the start of a sentence might indicate initial nervousness, while errors at the end could signal difficulty in concluding thoughts confidently. For example, an error at the start of a sentence may be “Um, I believe, uh, I worked on a project last year.” For example, an error at the end of a sentence may be “I managed a project successfully, um, I think.”

According, there is an importance of the misspoken word within the sentence. In embodiments, this evaluates whether the misspoken word is critical to the meaning or intent of the sentence. Keywords like action verbs or domain-specific terms carry more weight than auxiliary words. In embodiments, errors in critical words may reduce the impact or accuracy of the response. For example, a critical set of words may be “cost-saving strategy” in a sentence, such as “I increased the revenue by, um, implementing a, uh, cost-saving strategy.” (Misspeaking “cost-saving” impacts clarity.). Also, non-critical words are also evaluated within a sentence. For example, “I successfully implemented the strategy, uh, last year.” In embodiments, each critical word may be provided with a value that is different from each non-critical word. Based on the values, the system can determine whether the sentence has greater importance. Also, a score deduction may occur if a critical word is misspoken. In embodiments, the frequency of the misspoken word is also analyzed by tracking how often a specific word is misspoken or repeated incorrectly during the response: This analysis helps to determine that a repetition of errors may indicate a lack of familiarity with the topic or nervousness.

For example, “I, uh, worked on a, uh, project that, um, focused on a, um, cost-saving strategy.” As shown, this includes multiple repetitions of “uh” and “um” dilute the response clarity. Also, additional time taken to speak in relation to the word itself is also analyzed. In embodiments, this tracks pauses or delays associated with specific words, indicating hesitation or uncertainty. Extended pauses before or after a key word may suggest difficulty articulating thoughts or a lack of confidence. For example, “I managed a [pause] project last year [long pause], um, successfully.” Also, tone changes related to a particular word are analyzed. This evaluates fluctuations in tone (e.g., pitch, volume, emphasis) that occur when specific words are spoken. Inconsistent tone may signal uncertainty, lack of confidence, or difficulty with the word.

For example, a flat tone may be determined (“I managed a project and implemented a, um, cost-saving strategy.”). A shaky or rising tone may be also be determined (“I, uh, implemented a [rising tone] cost-saving strategy?”

In embodiments, the text is then sent from text processing unit 608 to AI engine 610. In embodiments, AI engine 610 assesses the content of the responses in real-time, providing objective scoring based on the quality, relevance, and clarity of the answers. Furthermore, as shown in FIG. 6, rules 612 are rules used by AI engine 610 to evaluate language, tone, and content, allowing users of interactive system 100 to improve their responses over time.

FIG. 7 shows an example communication flow diagram between different computing systems. As shown in FIG. 7, interactive system 100 has three sub-systems-metahuman 101, speech-to-text API 103, and AI engine 105. As shown in FIG. 7, metahuman 101 sends electronic communication 702 to user device 202. In embodiments, interactive system 100 and user device 202 may be part of the same system. In other embodiments, interactive system 100 and user device 202 may be separate computing devices.

At electronic communication 704, user device 202 sends a response to electronic communication 702. As shown in FIG. 7, electronic communication 704 is sent to metahuman 101. Also, user device 202 sends electronic communication 706 to speech-to-text API 103 which is part of interactive system 100. Accordingly, metahuman 101 and speech-to-text API electronically communicate with each other which results in result 708 which is text converted from electronic speech information sent by user device 202 via electronic communications 704 and 706.

As shown in FIG. 7, electronic communication 710 is sent from speech-to-text API 103 to AI Engine 105. In embodiments, AI Engine 105 analyzes the text (generated from the user's speech) and generates a score. In embodiments, the generated score determines who well the user responded to the question that was asked in electronic communication 702. As shown in FIG. 7, electronic communication 714 is sent to user device 202 and includes the score generated by AI Engine 105.

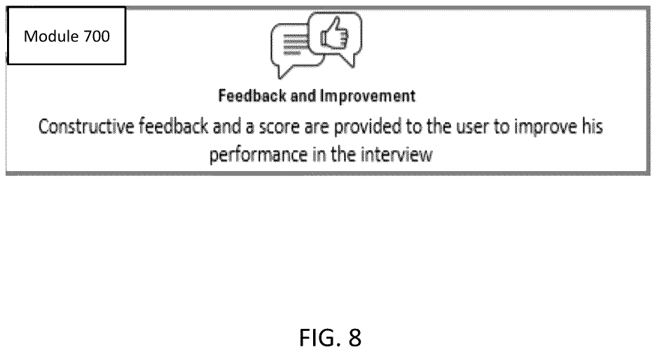

FIG. 8 further describes module 700. As shown in FIG. 8, the score (as generated by AI Engine 105) is used to provide constructive feedback to the user. For example, the score may include both numerical and non-numerical information, such as the score “80 out of 100” and “the user needs to slow down when answering questions.”

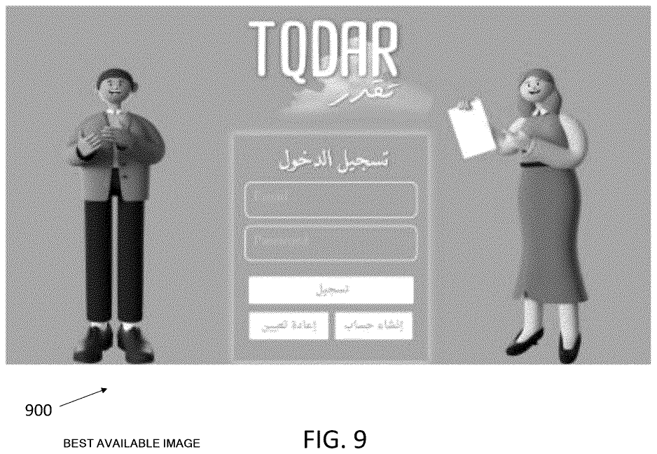

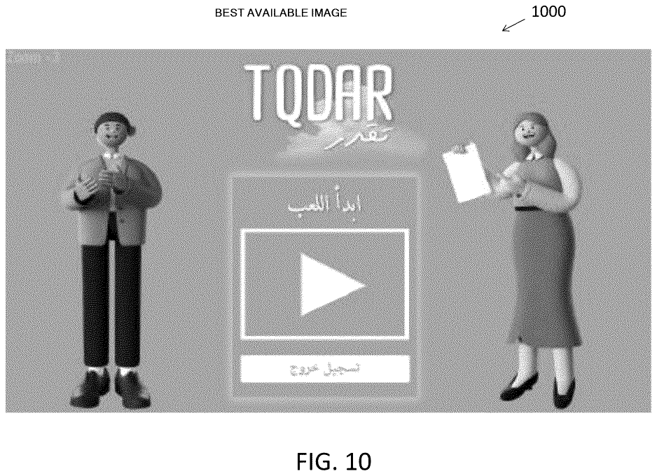

FIGS. 9 and 10 describe graphical display 900 and 1000, respectively. As shown in FIG. 9, graphical display 900 includes data fields that allow for a user to input electronic information. As shown in FIG. 10, graphical display 1000 includes a play icon which, when selected, starts the electronic interactive interview process.

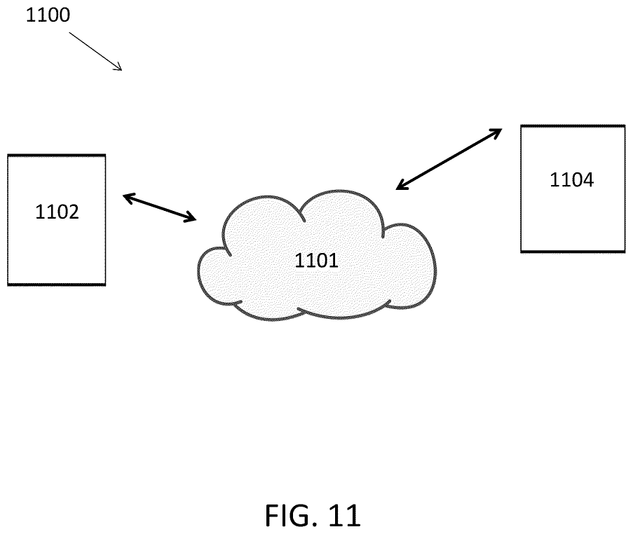

FIG. 11 is a diagram of example environment 1100 in which systems, devices, and/or methods described herein may be implemented. FIG. 11 shows network 1101, user device 1102, user device 1104, and interactive system 1106.

Network 1101 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or alternatively, network 1101 may include a cellular network, a public land mobile network (PLMN), a second generation (2G) network, a third generation (3G) network, a fourth generation (4G) network, a fifth generation (5G) network, and/or another network.

In embodiments, network 1101 may allow for devices describe any of the described figures to electronically communicate (e.g., using emails, electronic signals, URL links, web links, electronic bits, fiber optic signals, wireless signals, wired signals, etc.) with each other so as to send and receive various types of electronic communications.

User device 1102 and/or 1104 may include any computation or communications device that is capable of communicating with a network (e.g., network 1101). For example, user device 1102 and/or user device 1104 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 1102 and/or 1104 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 1102 and/or 1104. User device 1102 and/or 1104 may have a touch screen and/or a keyboard that allows a user to electronically interact with an electronic application. In embodiments, a user may swipe, press, or touch user device 1102 and/or 1104 in such a manner that one or more electronic actions will be initiated by user device 1102 and/or 1104 via an electronic application. User device 1102 and/or 1104 may receive/send electronic information from/to interactive system 1106 and generate and display graphs such as those described in the figures above.

User device 1102 and/or 1104 may include a variety of applications, such as, for example, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.). In embodiments, user device 1102 and/or 1104 may be used to generate graphs (such as those described in FIGS. 9 and 10) to model various features of the device described in FIG. 1.

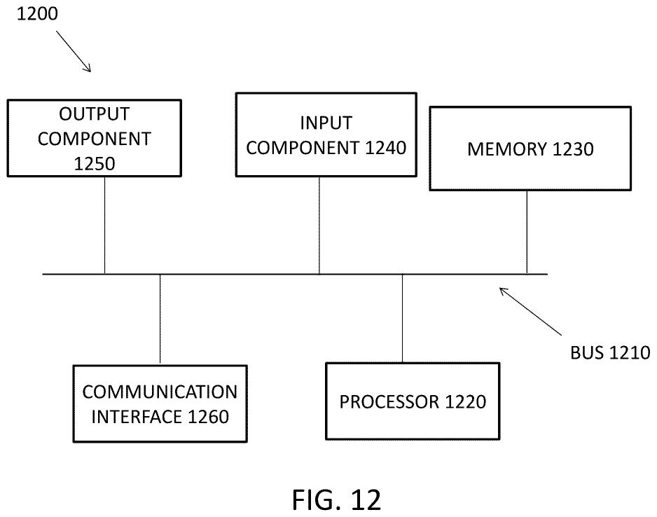

FIG. 12 is a diagram of example components of a device 1200. Device 1200 may correspond to user device 1202, or user device 1204. Alternatively, or additionally, user device 1202 and user device 1204 may include one or more devices 1200 and/or one or more components of device 1200.

As shown in FIG. 12, device 1200 may include a bus 1210, a processor 1220, a memory 1230, an input component 1240, an output component 1250, and a communications interface 1260. In other implementations, device 1200 may contain fewer components, additional components, different components, or differently arranged components than depicted in FIG. 12. Additionally, or alternatively, one or more components of device 1200 may perform one or more tasks described as being performed by one or more other components of device 1200.

Bus 1210 may include a path that permits communications among the components of device 1200. Processor 1220 may include one or more processors, microprocessors, or processing logic (e.g., a field programmable gate array (FPGA) or an application specific integrated circuit (ASIC)) that interprets and executes instructions. Memory 1230 may include any type of dynamic storage device that stores information and instructions, for execution by processor 1220, and/or any type of non-volatile storage device that stores information for use by processor 1220. Input component 1240 may include a mechanism that permits a user to input information to device 1200, such as a keyboard, a keypad, a button, a switch, voice command, etc. Output component 1250 may include a mechanism that outputs information to the user, such as a display, a speaker, one or more light emitting diodes (LEDs), etc.

Communications interface 1260 may include any transceiver-like mechanism that enables device 1200 to communicate with other devices and/or systems. For example, communications interface 1260 may include an Ethernet interface, an optical interface, a coaxial interface, a wireless interface, or the like.

In another implementation, communications interface 1260 may include, for example, a transmitter that may convert baseband signals from processor 1220 to radio frequency (RF) signals and/or a receiver that may convert RF signals to baseband signals. Alternatively, communications interface 1260 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 1260 may connect to an antenna assembly (not shown in FIG. 12) for transmission and/or reception of the RF signals. The antenna assembly may include one or more antennas to transmit and/or receive RF signals over the air. The antenna assembly may, for example, receive RF signals from communications interface 1260 and transmit the RF signals over the air, and receive RF signals over the air and provide the RF signals to communications interface 1260. In one implementation, for example, communications interface 1260 may communicate with network 1101.

As will be described in detail below, device 1200 may perform certain operations. Device 1200 may perform these operations in response to processor 1220 executing software instructions (e.g., computer program(s)) contained in a computer-readable medium, such as memory 630, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 630 from another computer-readable medium or from another device. The software instructions contained in memory 1230 may cause processor 620 to perform processes described herein. Alternatively, hardwired circuitry may be used in place of or in combination with software instructions to implement processes described herein. Thus, implementations described herein are not limited to any specific combination of hardware circuitry and software.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 12, to complete such actions.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a computing device, electronic imagery;
receiving, by the computing device, electronic sound information;
determining, by the computing device, an electronically generated face based on the electronic imagery and the electronic sound information;
receiving, by the computing device, additional electronic sound information; and
determining, by the computing device, to change the electronically generated face based on the additional electronic information.

2. The method of claim 1, wherein the electronic sound information includes a time period between two words that is less than another time period between two other words in the additional electronic sound information.

3. The method of claim 1, wherein a word within the electronic sound information is classified as critical.

4. The method of claim 1, wherein another word within the electronic sound information is classified as non-critical.

5. A device, comprising:
memory, and
a processor, coupled to the memory, the processor to:
receive electronic imagery;
receive electronic sound information;
determine an electronically generated face based on the electronic imagery and the electronic sound information;
receive additional electronic information; and
determine to change the electronically generated face based on the additional electronic sound information.

6. The device of claim 1, wherein the electronic sound information includes a critical word.

7. The device of claim 5, wherein the electronic sound information, includes a non-critical word.
